(19) United States
(12) Patent Application Publication
(10) Pub. No.: US 2021/0263983 A1
(43) Pub. Date: Aug. 26, 2021

(54) SYSTEM AND METHOD FOR MULTI-DOMAIN PERSONAL INTEREST EXPANSION

(71) Applicant: Toshiba TEC Kabushiki Kaisha, Shinagawa-ku (JP)

(72) Inventor: John N. deWaide, Lake Forest, CA (US)

(21) Appl. No.: 16/801,882

(22) Filed: Feb. 26, 2020

(51) Int. Cl. G06F 16/9535; G06F 16/9536; G06F 16/435; G06F 16/483

(52) U.S. Cl. CPC G06F 16/9535; G06F 16/483; G06F 16/435; G06F 16/9536

(57) ABSTRACT

A system and method for providing users with access to expanded content relating to their personal interests, purchases or proclivities, uses prior user activities to determine and expand upon their interests. Information from a user's web browser history, search history, video stream selections, television show selections, movie selections, purchases and activities is gathered and metadata is extracted. Categories of interest are associated with extracted metadata, and are associated with a positivity level relative to the user, such as ratings, likes, frequency of use, postings, and the like. Categories with sufficiently high positivity are subject to an inter-domain search which returns additional content that may be of particular interest to the user.

### TECHNICAL FIELD

This application relates generally to generating personalized entertainment content. The application relates more particularly to capture of a user's entertainment proclivities from their historic selections and interactions with entertainment content, and generating of new entertainment content relevant to the user.

### BACKGROUND

Users interact with Internet web content on a daily basis. The Internet has evolved into a massive shopping venue. Many traditional brick-and-mortar shopping venues are disappearing as more purchases are done online. As to be expected, the Internet has also evolved into a major advertising arena. Sophisticated research engine sites monitor user interactions in order to determine what type of products or services might be of interest to them. Users are then subject to targeted advertising, and online retailers will pay the research engine site a fee when a user clicks on an advertisement stemming from targeted advertising. This model is specifically tailored for online retailers. User tastes or desires are monitored for the purpose of selling products.

### BRIEF DESCRIPTION OF THE DRAWINGS

Various embodiments will become better understood with regard to the following description, appended claims and accompanying drawings wherein:

FIG. 1 is an example embodiment of a system for multi-domain personal interest expansion;

FIG. 2 is a flowchart of an example embodiment of a system for multi-domain personal interest expansion;

FIG. 3 is an example embodiment of a digital device system;

FIG. 4 is an example embodiment of a system diagram for multi-domain personal interest expansion;

FIG. 5 is an example embodiment of a user notification system comprised of an entertainment assistant cloud service; and

FIG. 6 is an example embodiment of a software module block diagram for multi-domain interest expansion.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with example embodiments disclosed herein, systems and methods are taught to provide users with resources that are of specific personal interest to them. Unlike targeted advertising, as noted above, example embodiments target the interests of users, and not businesses. A user's taste in items such as music, television shows, movies, websites or streaming content is determined, and the user is provided with additional content that will allow the user to expand upon their interests.

Example embodiments herein aggregate a multitude of disparate, available user-to-entertainment-artifact interaction histories, determine an importance of the interactions, and select one or more of the top entertainment artifacts. The system then performs a multi-domain search and analysis utilizing natural language processing to find the most relevant multi-domain recommendations for each particular user. Examples include, but are not limited to Amazon merchandise, YouTube videos, streaming movies or shows, public events or gatherings, conventions, concert tickets, online articles, blogs, and the like.

The system specifically aims to expand the user's interests by way of recommending virtually anything which could be arrived at by Internet searches. It is not limited to things which are consumed online. It attempts to do the Internet searching work for the user that they would typically have to perform manually if the actively sought to expand their interests. Unlike recommendations from sites such as Amazon or Facebook or YouTube, it has a user-centric approach, not an advertisement-centric approach, and spans multiple domains.

In a further example embodiment, a mobile application allows a user to sync with as many accounts containing searchable entertainment-interactions as possible. A backend service is responsible for collecting data. Example information includes scrubbing Facebook “Like” data and posting habits, Amazon purchase history, Netflix/Hulu/Amazon viewing history, YouTube viewing history, online TV viewing history if available, and Internet browsing history, among others.

When initial entertainment artifacts are identified, relevant metadata is extracted from comments and interactions which are deemed positive by the natural language processor. Extracted metadata tags are stored and a multi-domain search with that metadata is completed with accounts linked to the app. For example, if a user has been watching a lot of nature and space documentaries on Netflix, there could be a public bird-watching or star-gazing Facebook event nearby with similar metadata that could be recommended.

When a user interacts with a recommendation, metadata tags are stored so as to be available for the next multi-domain search. This allows recommendations to get more specific as the user's interests evolve.

Natural language processing, when applied, assists in assuring that feedback on extracted content is positive, thus helping to refine the results. By linking a user's media accounts together, data can be extracted which targets that user's preferences across multiple domains. The provided domains can then be searched using tags extracted which are related to the user's preferences. When a user positively interacts with a recommendation from the system, metadata tags unique to this recommendation are extracted, stored and used to power a next set of recommendations. This allows recommendations to get more and more specific the more a user shows positive interactions and could allow the user to discover new interests.

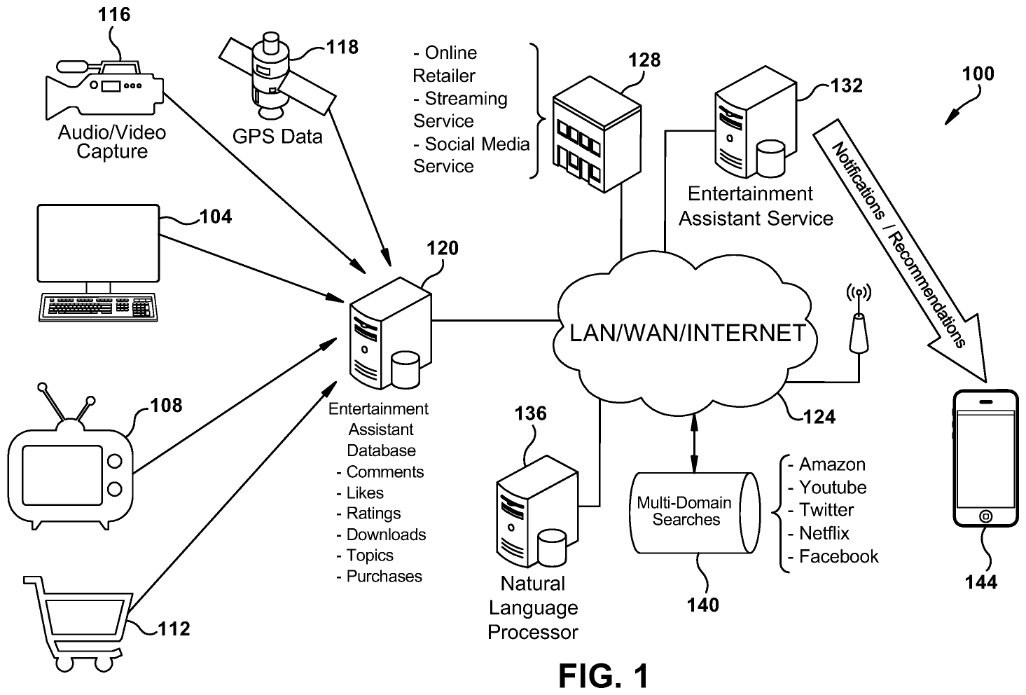

In accordance with the subject application, FIG. 1 illustrates an example embodiment of a system 100 for multi-domain personal interest expansion. In the example, a user interacts with various devices in connection with their personal interests. Example personal interests include sports, such as watching sporting event broadcasts or attending live events, fantasy league participation, or listening to or watching sports commentaries, or participating in discussions. Users will have interests in more specific aspects of such categories, such as college football or professional basketball, or purchasing and collecting sports memorabilia. Other example personal interests include movies, books, television shows, art, social media, travel, science or nature. In the example of FIG. 1, a user interacts with various electronic devices, such as computer 104 and television 108. A user's web history, including history of streaming content, postings to social media, and the like provide indicators as to a user's particular interest. Further indicators may include prior purchases, either online or offline as indicated by shopping cart 112, as well as a user's current or past locations, as well as video or audio captures. Such as via camera 116. Images taken by users may, for example, form posts to social media sites. A user's location information, such as by GPS tracking 118 on their smartphone, can indicate where the user has travelled, such as past vacation spots. A proclivity for travel to beaches, for example, provides an indication that the user's interest includes beach vacations. Information from any or all of these areas is captured into entertainment assistant database server 120, which is connected to a network cloud 124. Network cloud 124 is suitably comprised of a local area network (LAN), a wide area network (WAN) which may comprise the Internet, or any suitable combination thereof. Also connected to network cloud 124 are content providers, such as business entities 128, including online retailers, such as Amazon or Rakuten, streaming services, such as Hulu or Netflix, and social media services such as Facebook, Twitter or Instagram.

In the example embodiment of FIG. 1, entertainment assistant service 132 obtains user specific information from entertainment assistant database server 120. Metadata, which may include keywords, contextual information, information tags, or the like, is extracted and saved. This metadata is suitably ranked to determine a positivity level or ratio. By way of further example, the user may have rated a product or vacation spot highly, given a Facebook like to a particular topic, or retweeted messages on Twitter relative to selected topics. Metadata that is ranked sufficiently positively, such achieving a preset threshold level or ratio level of positivity versus negativity, is used in connection with natural language processing server 136 to form multi-domain search 140 for content related to the user's particular proclivities. This content is assembled by entertainment assistant service 132 and relayed to the user, such as via a smartphone, workstation, notebook or tablet computer, illustrated with smartphone 144.

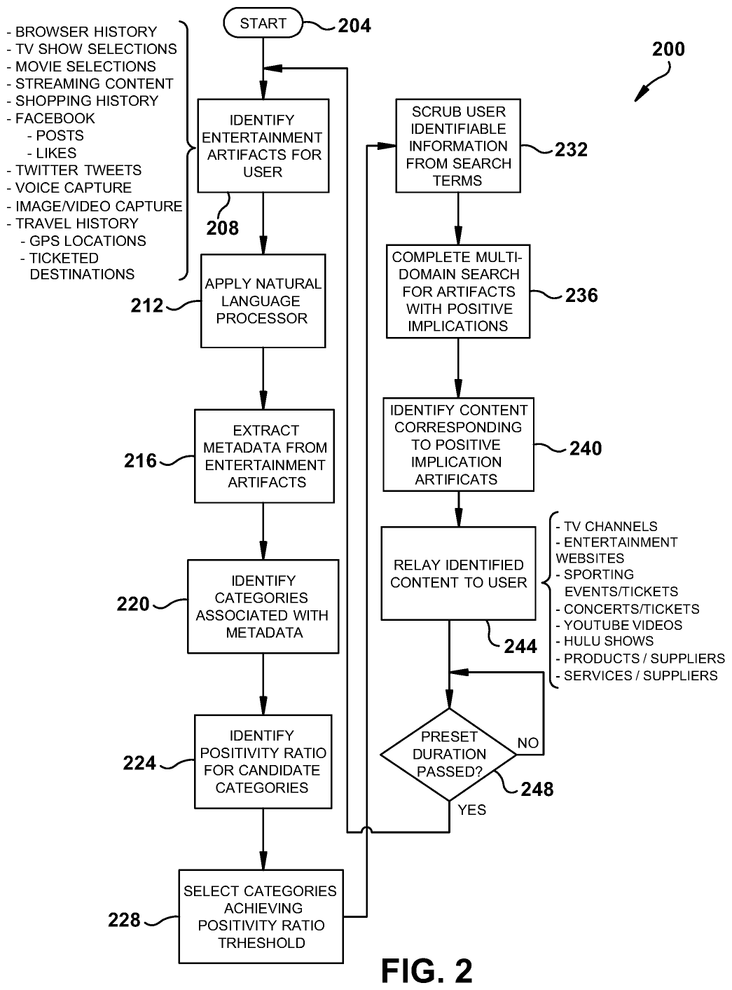

FIG. 2 is a flowchart 200 of an example embodiment of a system for multi-domain personal interest expansion. The process commences at block 204 and proceeds to block 208 where user artifacts are identified. Natural language processor is enabled at block 212 to assist in extracting metadata from artifacts at block 216 and to facilitate searching. Metadata categories are determined at block 220, and a positivity ratio is identified for candidate categories at block 224. Categories having sufficient positivity are determined and selected at block 228. Any personally identifiable information, such as usernames, names, addresses, phone numbers or email addresses, is scrubbed at block 232 prior to completing a multi-domain search at block 236. A user may also provide specific instructions if they want to opt out of certain areas or topics. For example, some searching may be for private matters and the user does not which to have expanded information searched for and returned. Relevant content is identified and retrieved at block 240, and relayed to the user at block 244. The process is suitably rerun periodically to supplement and update the user's proclivities at block 248.

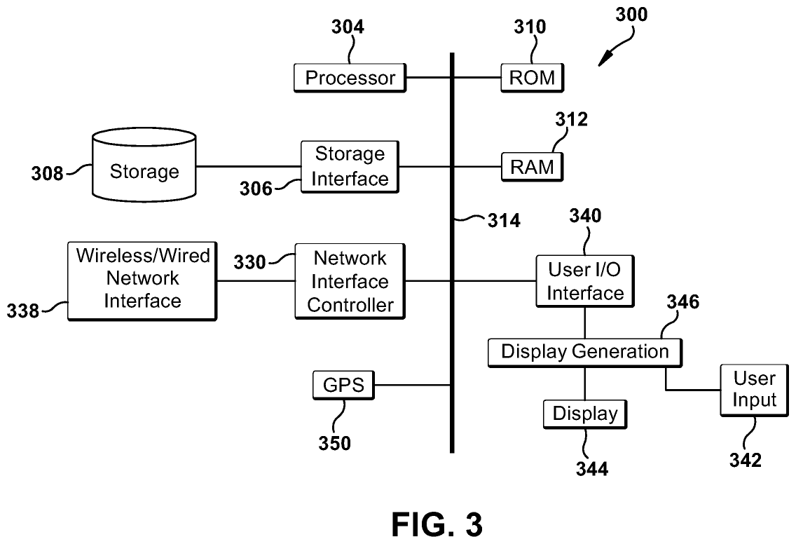

Turning now to FIG. 3, illustrated is an example embodiment of a digital device system 300 suitably comprising servers or smartphone of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless or wired network interface 338. A suitable data connection to a computing device or server is via a data network, such as a local area network (LAN), a wide arear network (WAN), which may comprise the Internet, or any suitable combination thereof. A digital data connection is also suitably directly with a computing device or server, such as via Bluetooth, optical data transfer, Wi-Fi direct, or the like.

Processor 304 is also in data communication with a user input/output (I/O) interface 340 which provides data communication with user peripherals, such as user input 342 and display 344 via display generator 346. Suitable user interfaces include touchscreens, as well as keyboards, mice, track balls, touch screens, or the like. It will be understood that functional units are suitably comprised of intelligent units, including any suitable hardware or software platform. Also in data communication with processor 304 is GPS interface 350.

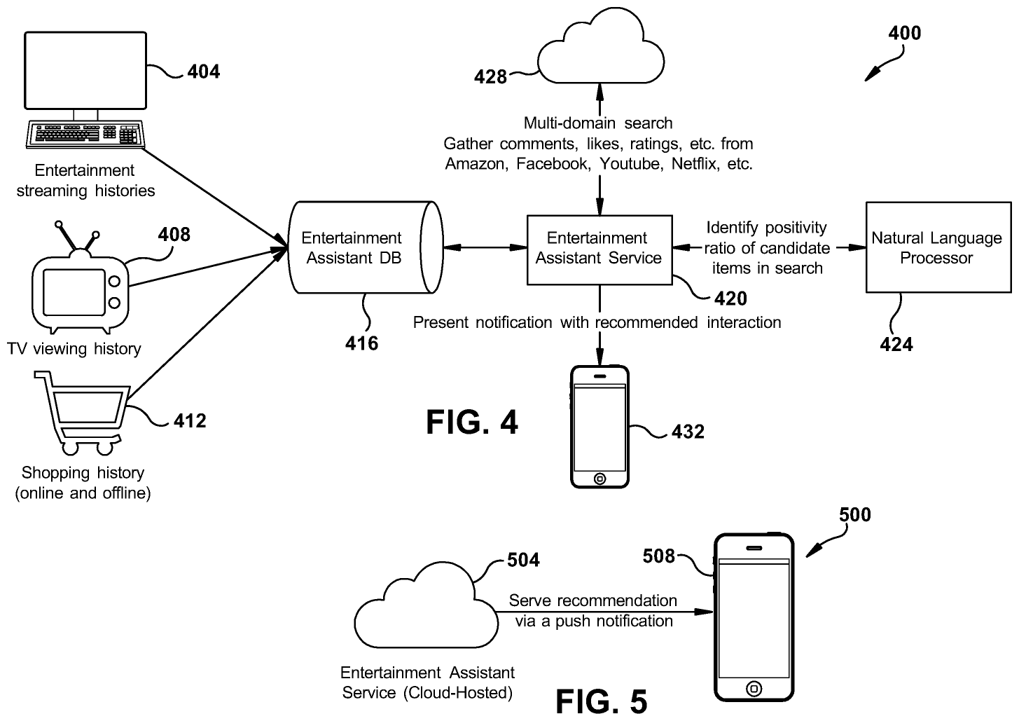

FIG. 4 is a system diagram 400 of a system for multi-domain personal interest expansion. User proclivities are obtained from example sources such as entertainment streaming histories 404, TV viewing history 408 or offline/online shopping history 412. Resultant artifacts are collected on entertainment assistant database 416 and made available to entertainment assistant service 420. Entertainment assistant service 420 uses natural language processor 424 to identify candidates with sufficiently high positivity. These candidates are used for multi-domain search 428, and the results are relayed to user device 432.

FIG. 5 illustrates an example embodiment of user notification system 500 comprised of an entertainment assistant cloud service 504, suitably comprising the resources of an entertainment system database, natural language processor, entertainment assistant service and multi-domain searching as detailed above. In the illustrated example, the entertainment assistant cloud service 504 serves recommendations to a user's smartphone 508 via push notifications, however any suitable personal computing device can receive recommendations via any suitable communications means as would be understood in the art.

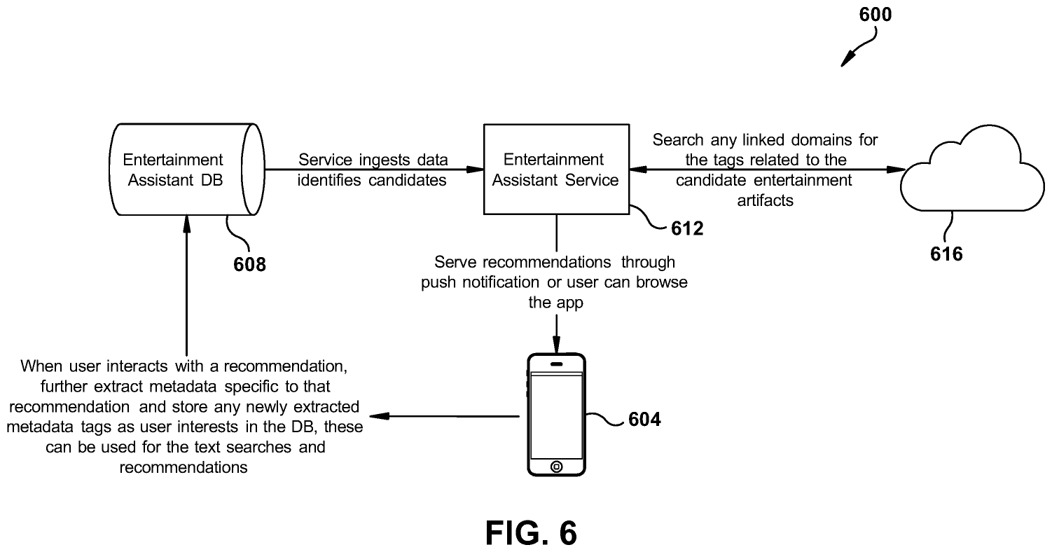

FIG. 6 is an example embodiment of a software module block diagram 600 for multi-domain interest expansion. A user interacts with their personal device, such as smartphone 604, in their usual manner. This may include browsing, shopping, gaming, streaming or purchasing. Extracted information is provided to entertainment assistant database 608, which ingests the information and returns identified candidates to entertainment assistant service 612. Entertainment assistant service 612 completes a multi-domain search on network cloud 616, and returned information, such as recommended content, is pushed or otherwise made available back at the user's smartphone 604, or any other suitable device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
memory;
a data interface;
a geolocation system configured to generate location data corresponding to tracked movement and location of an identified user; and
a processor,
the processor configured to receive user-to-entertainment artifact interaction data corresponding to the identified user via the data interface,
the processor further configured to determine a travel history of the identified user in accordance with generated location data,
the processor further configured to extract metadata corresponding to one or more content categories from received artifact interaction data,
the processor further configured to identify positive user association with one or more content categories in accordance with extracted metadata and a determined travel history of the identified user,
the processor further configured to complete a multi-domain network search for each content category identified as positive, and
the processor further configured to communicate results from the multi-domain network search to a user device associated with the identified user.

2. The system of claim 1 wherein the artifact interaction data includes two or more of user browser history, user entertainment choices, user travel history, user posts or user purchase history.

3. The system of claim 2 wherein the processor is further configured to extract the metadata in accordance with natural language processing of the artifact interaction data.

4. The system of claim 3 wherein the processor is further configured to complete the multi-domain network search without any user identifiable information.

5. The system of claim 3 wherein the processor is further configured to communicate the results from the multi-domain network search as one or more of audio content, video content, websites, events, products or services.

6. The system of claim 5 wherein the results from the multi-domain network search include supplier links for products or services, ticketing services for events, travel destinations or identification of sources for video or audio content.

7. The system of claim 6 wherein the processor is further configured to periodically receive updated user-to-artifact interaction data so as to generate updated results from a new multi-domain network search.

8. The system of claim 1 wherein the processor is further configured to:
determine a positivity ratio for each content category associated with extracted data, and
selecting content categories associated with positivity ratios above a preselected threshold.

9. A method comprising:
receiving user-to-entertainment artifact interaction data corresponding to an identified user via a data interface;
generating location data corresponding to tracked movement and location of the identified user;
determining a travel history of the identified user in accordance with generated location data;
extracting, via a processor, metadata corresponding to one or more content categories from received artifact interaction data;
identify positive user association with one or more content categories in accordance with extracted metadata and a determined travel history of the identified user via the processor;
completing, via the processor, a multi-domain network search for each content category identified as positive; and
communicating results from the multi-domain network search to a user device associated with the identified user via the data interface.

10. The method of claim 9 wherein the artifact interaction data includes two or more of user browser history, user entertainment choices, user travel history, user posts or user purchase history.

11. The method of claim 10 further comprising extracting the metadata in accordance with natural language processing of the artifact interaction data.

12. The method of claim 11 further comprising completing multi-domain network search without any user identifiable information.

13. The method of claim 12 further comprising communicating the results from the multi-domain network search to one or more of audio content, video content, websites, events, products and services.

14. The method of claim 13 wherein the results from the multi-domain network search include supplier links for products or services, ticketing services for events, travel destinations or identification of sources for video or audio content.

15. The method of claim 14 further comprising periodically receiving updated user-to-artifact interaction data so as to generate updated results from a new multi-domain network search.

16. The method of claim 9 further comprising:
determining a positivity ratio for each content category associated with extracted data, and
selecting content categories associated with positivity ratios above a preselected threshold.

17. A method comprising:
establishing a data connection with a computer of an identified user via a data interface;
retrieving, into memory, browser history data from the computer via the data interface;
retrieving, into the memory, purchase history data corresponding to prior purchases made by the user;
generating location data corresponding to tracked movement and location of the user;
extracting metadata from the browser history data and the purchase history data;
identifying entertainment artifacts directed to the user in accordance with extracted metadata;
determining a travel history of the user in accordance with generated location data;
performing a multi-domain search in accordance with identified artifacts and determined travel history of the user;
receiving entertainment content from the multi-domain search corresponding to the identified artifacts; and
displaying received entertainment content to the identified user on a user interface display.

18. The method of claim 17 wherein the entertainment content include one or more of sports, movies, events, websites, products, services or music preferences associated with the user.

19. The method of claim 18 further comprising identifying a subset of entertainment artifacts as being indicative of a positive association with the user, and performing the multi-domain search on the identified subset of entertainment artifacts.

20. (canceled)
